(19) United States
(12) Patent Application Publication
(10) Pub. No.: US 2018/0101659 A1
(43) Pub. Date: Apr. 12, 2018

(54) METHODS, DEVICES, AND SYSTEMS FOR IDENTIFYING, MONITORING, AND TREATING A MENTAL HEALTH DISORDER

(71) Applicant: eMind Science Corp., Greenville, NC (US)

(72) Inventors: Philip T. Ninan, Greenville, NC (US); Michael Heffernan, Washington, NC (US)

(21) Appl. No.: 15/722,729

(22) Filed: Oct. 2, 2017

Related U.S. Application Data
(60) Provisional application No. 62/405,563, filed on Oct. 7, 2016.

(51) Int. Cl. G06F 19/00

(52) U.S. Cl. CPC G06F 19/3431; G06F 19/3406; G06F 19/328; G06F 19/363

(57) ABSTRACT

The presently disclosed subject matter is directed to systems, devices, and methods that provide measurement and monitoring of mental health well-being of a patient for a healthcare provider. In some embodiments the method includes; receiving contact information for the patient from a remote computing device; transmitting a plurality of questions for the patient to the remote computing device, wherein the remote computing device is configured to display the plurality of questions and receive a plurality of responses to the questions from the patient; receiving the plurality of responses to the questions from the remote computing device indicating a mental health status of the patient; determining trends indicative of the mental health well-being of the patient based on the plurality of responses to the questions; transmitting at least a first portion of the trends to the remote computing device; and transmitting at least a second portion of the trends to a healthcare provider's computing device.

### PRIORITY CLAIM

This application claims priority to U.S. Provisional Patent Application Ser. No. 62/405,563; entitled “SYSTEM AND METHOD FOR IDENTIFYING, MONITORING, AND TREATING A MENTAL HEALTH DISORDER”; and filed Oct. 7, 2016, the disclosure of which is incorporated herein by reference in its entirety.

### TECHNICAL FIELD

The present invention relates to a web application, a mobile device application, and a backend infrastructure; and more specifically, to methods, devices, and systems for identifying, monitoring, and/or treating the medical signs and symptoms of mental health.

### BACKGROUND

Neuroscientific research has shown that two critical systems of an individual's brain are response to threat and reward. Their functional states manifest as stress, anxiety and depression. Anxiety, anger and sadness are derived from the threat system, and lack of pleasure comes from under-activity of the reward system. For diagnostic and treatment purposes, a daily log can be one of the most effective means for following the course of an individual's (e.g. patient's) mental health and well-being (including stress, anxiety, depression and other related disorders). Without a daily log, it is almost impossible for health care professionals to follow reliably and validly the impact of various treatments (medications, talk, and other therapies, etc.) over the course of days, months, or even years. However, it can be difficult to motivate users to record their daily assessments of mental health status.

Accordingly, a need exists for a secure system that self-records and automatically tracks the medical signs and symptoms reflecting their mental health status, and directly provides the information to a health care professional repeatedly over time.

### SUMMARY

The presently disclosed subject matter solves the problem of automatically tracking the medical signs and symptoms reflecting the mental health status of a patient, and directly providing the information to a health care professional repeatedly over time. Specifically disclosed are systems, devices, and methods that provide measurement and monitoring of mental health well-being of a patient for a healthcare provider.

According to one embodiment, a method includes; receiving contact information for the patient from a remote computing device; transmitting a plurality of questions for the patient to the remote computing device, wherein the remote computing device is configured to display the plurality of questions and receive a plurality of responses to the questions from the patient; receiving the plurality of responses to the questions from the remote computing device indicating a mental health status of the patient; determining trends indicative of the mental health well-being of the patient based on the plurality of responses to the questions; transmitting at least a first portion of the trends to the remote computing device; and transmitting at least a second portion of the trends to a healthcare provider's computing device.

In some embodiments, the method may further include providing Health Insurance Portability and Accountability Act (HIPAA) compliant access for the remote computing device and providing HIPAA compliant communication to the healthcare provider's computing device.

The second portion of the trends may be formatted to be used to determine a course of treatment for the patient by the healthcare provider and transmitting the second portion of the trends may be based on the plurality of responses to the questions exceeding at least one of a specified criterion for a predefined action and a predefined severity level to a single response.

In some embodiments, the plurality of questions may be transmitted to the remote computing device on a periodic interval. The plurality of questions may request information from the patient based on emotions, thoughts, and/or behaviors. The remote computing device may a smartphone, a tablet, a laptop, or a personal computer.

The plurality of questions may be displayed to the patient and the plurality of responses may be received from the patient via a graphical user interface (GUI). The GUI may be provided by an application specific program. In other embodiments, the GUI may be provided by a web browser. In certain embodiments, the web browser may be a Microsoft Internet Explorer® browser, a Microsoft Edge® browser, an Apple Safari® browser, a Google Chrome® browser, a Mozilla Firefox® browser, or an Opera® browser.

In another embodiment, a server provides measurement and monitoring of mental health well-being of a patient for a healthcare provider. The server includes at least a memory, a database, and a processor. The processor is configured for receiving contact information for the patient from a remote computing device; transmitting a plurality of questions for the patient to the remote computing device, wherein the remote computing device is configured to display the plurality of questions and receive a plurality of responses to the questions from the patient; receiving the plurality of responses to the questions from the remote computing device indicating a mental health status of the patient; determining trends indicative of the mental health well-being of the patient based on the plurality of responses to the questions; transmitting at least a first portion of the trends to the remote computing device; and transmitting at least a second portion of the trends to a healthcare provider's computing device. The processor may be further configured for providing Health Insurance Portability and Accountability Act (HIPAA) compliant access for the remote computing device and provides HIPAA compliant communication to the healthcare provider's computing device.

In another embodiment, a non-transitory computer readable medium includes a plurality of machine-readable instructions which when executed by one or more processors of a server are adapted to cause the server to perform a method for providing measuring and monitoring a mental health well-being of a patient for a healthcare provider. The method includes providing Health Insurance Portability and Accountability Act (HIPAA) compliant access for a remote computing device of the patient using a first secure web portal and providing HIPPA compliant access to a healthcare provider's computing device using a second secure web portal. The method further includes receiving contact information for the patient from the remote computing device and transmitting a plurality of questions for the patient to the remote computing device requesting information from the patient based on emotions, thoughts, and/or behaviors. The remote computing device is configured to display the plurality of questions and receive a plurality of responses from the patient.

The method further includes receiving the plurality of responses to the questions from the remote computing device indicating a mental health status of the patient and determining trends indicative of the mental health well-being of the patient based on the plurality of responses to the questions; transmitting at least a first portion of the trends to the remote computing device; and transmitting at least a second portion of the trends to the healthcare provider's computing device based on the plurality of responses to the questions exceeding at least one of a specified criterion for a predefined action and a predefined severity level to a single response.

### BRIEF DESCRIPTION OF THE DRAWINGS

The present embodiments are illustrated by way of example and are not intended to be limited by the figures of the accompanying drawings. In the drawings:

FIG. 1 illustrates a remote computer device graphical user interface (GUI) displaying a plurality of questions in accordance with embodiments of the present disclosure.

FIG. 2 illustrates a block diagram of a system for providing measurement and monitoring of mental health well-being of a patient for a healthcare provider in accordance with embodiments of the present disclosure.

FIG. 3 illustrates a remote computer device GUI displaying a plurality of questions in accordance with embodiments of the present disclosure.

FIG. 4 illustrates a remote computer device GUI displaying a report summary of a patient's symptoms in accordance with embodiments of the present disclosure.

FIG. 5 illustrates a remote computer device GUI displaying a patient's symptoms as a bar chart for daily scores in accordance with embodiments of the present disclosure.

FIG. 6A illustrates a remote computer device GUI displaying a patient's symptoms as a histogram with weekly intervals in accordance with embodiments of the present disclosure.

FIG. 6B illustrates a remote computer device GUI displaying a patient's symptoms as an x-y plot over time in accordance with embodiments of the present disclosure.

FIG. 7 illustrates a block diagram of a server in accordance with embodiments of the present disclosure.

FIG. 8 illustrates a block diagram of a personal computer in accordance with embodiments of the present disclosure.

FIG. 9 illustrates a block diagram of a smartphone in accordance with embodiments of the present disclosure.

FIG. 10 illustrates a flow chart in accordance with embodiments of the present disclosure.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

As used herein, a remote computing device may be any computing device providing a user input, display, and connectivity to one or more servers over a personal area network (PAN), a local area network (LAN) and/or a wide area network (WAN). The PAN may include Bluetooth® or Universal Serial Bus (USB). The LAN may include any combination of wired Ethernet and/or Wi-Fi access points. The WAN may include the Internet and/or another wide area private network. The WAN may also include any combination of 2G, 3G, 4G, and 5G networks. In some embodiments the WAN may include Data Over Cable Service Interface Specification (DOCSIS) networks and/or fiber networks such as passive optical networks (PONs). Access to the one or more servers may also be provided via a virtual private network (VPN) within any of the previously described networks.

The remote computing device may be a fixed device or a mobile device. For example a fixed device may be an interactive kiosk, a personal computer, or the like. A mobile device may be any computing device capable of being transported easily from a location to another location without undue difficulty and one that is capable of functional connection with a remote server regardless of its location. For example a mobile device may be a smart phone, a tablet, a personal digital assistant, a laptop, or the like.

As used herein, the term “app” or “application” is used to indicate a software program that runs locally on a computing device or runs remotely via the functional connection to a web server.

As used herein, “software” processes may include, for example, software and/or hardware entities that perform work over time, such as tasks, threads, and intelligent agents. Also, each process can refer to multiple processes, for carrying out instructions in sequence or in parallel, continuously or intermittently.

As used herein, the term “secure” means user (e.g. patient) data is protected against free access by unauthorized entities thereby ensuring the Health Insurance Portability and Accountability Act (HIPAA) privacy rule compliance. The term “user” and “patient” is used interchangeably throughout this specification.

The presently disclosed subject matter solves the problem of automatically tracking the medical signs and symptoms reflecting the mental health status of a patient, and directly providing the information to a health care professional repeatedly over time. Specifically disclosed are systems, devices, and methods that provide measurement and monitoring of mental health well-being of a patient for a healthcare provider.

The presently disclosed subject matter is directed to devices, systems, and methods that enable the measurement of a user's vital sign of the mind to ascertain mental well-being. The vital sign may include (but is not limited to) any monitored characteristic through self-measurement. In some embodiments, the vital sign can be used to identify, monitor, and/or treat a user's mental health disorder. Thus, the disclosed devices, systems, and methods advantageously provide technology to allow user self-measurement and monitoring of mental health well-being.

The disclosed system can be configured as an app or through a website. In use, a user first downloads the app or goes to the website to register and log onto the disclosed system. In some embodiments, the user registers by creating a unique ID and/or password that identifies the user in the system. The disclosed system may be combined with mobile technology, such that a user can enter the system with a mobile device by simply going to the website and/or opening the app.

The disclosed system is a neuroscience-based personal tracking tool based on self-measurement that computes the most common distressing experiences, such as anxiety and depression. Particularly, the disclosed system guides users to privately quantify specific emotions, thinking patterns, and/or behaviors on a daily and/or weekly basis. The disclosed system therefore enables the self-measurement of a user's vital signs of the mind with dashboard reporting delivered across mobile platforms, thereby meeting HIPAA requirements with encryption within a cloud service.

A system dashboard allows users to track the vital signs of the mind by answering questions that are grounded in neuroscience and psychology. Particularly, the system provides a unique set of questions for a particular user (e.g. patient) to ascertain mental well-being. The disclosed system can comprise contacting the user using a wireless service that sends a message to the user's mobile device. For example the message may be received by the use as a short message service (SMS) message or a multimedia messaging service (MMS) message. In other embodiments, the user may access the questions directly by logging into the system using a secure web portal. The web portal may be accessed by the user using a remote computing device as disclosed earlier.

In some embodiments, the questions may include various terms and a unique description of the meaning of each term. The questions may be tailored to a particular user, allowing the user to self-measure well-being as it relates to certain health conditions and/or disease management unique to the user. Questions may be provided to the user daily, such as short series of questions geared towards the user's emotions, thoughts, and behaviors. Emotions are subjective feelings experienced by the user and are not logical. A user's emotions may trigger related thoughts and behaviors. Thoughts may be ideas of the user. User thoughts may be reasoned, logical and flexible to changing situations. Intense user emotions may deeply influence a user's thoughts. Behaviors may be actions driven by the user's thoughts and emotions. Intense emotions may make a user's behaviors reactive, limiting their choice of actions.

In some embodiments, weekly questions may be provided, directed to associated symptoms, stresses, interpersonal relationships, quality of life, function, and the like. In some embodiments, the presently disclosed enables the monitoring of a user's mental phenomenon, such as mood (e.g., depression or mania), pain, and/or anxiety for diagnostic and/or treatment purposes through answering questions. For example the user may be asked:
Sad thought focuses on loss, guilt, worthlessness and hopelessness.
   How sad have your thoughts been during the past 24 hours?
Impulsivity is acting without thinking or considering the consequences. Lacking self-control.
   How impulsive has your behavior been during the past 24 hours?

A user interface may be provided by a web application and may communicate over a secure web portal to a centralized server. After the plurality of questions has been provided, the user may then self-assess mood, anxiety, and the like by responding to the questions. In some embodiments, each question includes a plurality of selectable responses indicating an occurrence frequency from within a defined frequency range. In some embodiments, the questions may be answered by selecting a number on a scale (1-10, for example). The answers given by the user may be designated through any method known in the art. For example, the answers may be designated by pressing a button, clicking a button, touching a screen, using one or more forms (e.g., electronic form), using one or more marks (e.g., checkmarks), and/or using one or more lists (e.g., a checklist).

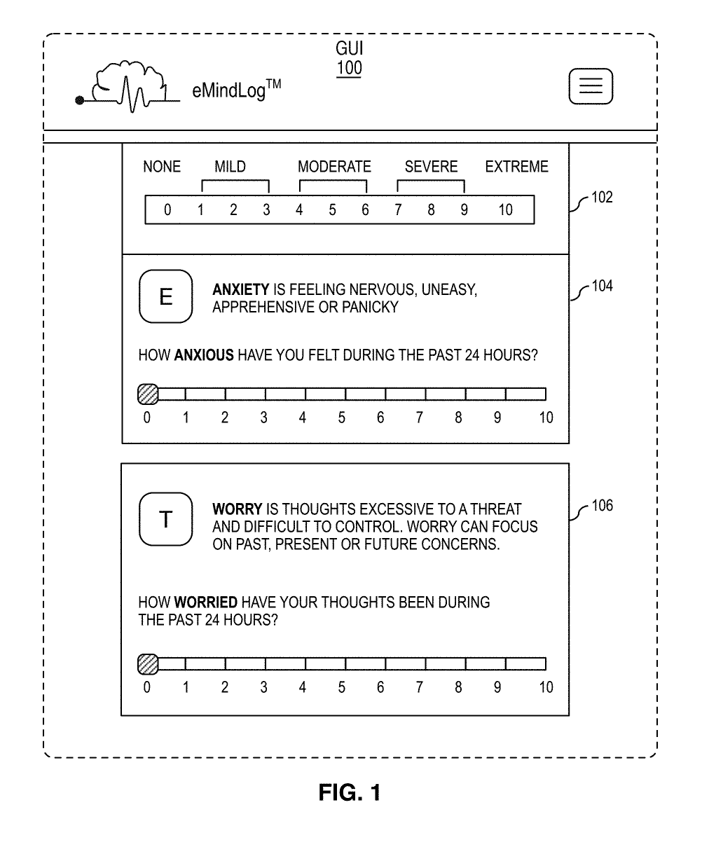

FIG. 1 illustrates an example of a graphical user interface (GUI) 100 displaying a plurality of questions in accordance with embodiments of the present disclosure. The GUI 100 may be displayed on any remote computing device as disclosed earlier in this specification. A bar graph key 102 is displayed at the top of the GUI 100. Severity levels from 0-10 are displayed, with 0 being none to 10 being extreme, with intermediate levels including mild, moderate, and severe. An emotion category question 104 and a thought category question 106 are also displayed in the GUI 100.

Answers to the questions provide indexes for anxiety, anger, sadness, lack of pleasure, etc., that influence mental well-being of the user. Particularly, the presently disclosed system include various algorithms designed to analyze and calculate the differences between emotions, thoughts, behaviors, and the underlying indexes used to measure anxiety, anger, sadness, lack of pleasure, etc. for daily analysis and stress, interpersonal relationships, quality of life, associated symptoms, and function. Thus, by answering the questions, a user can self-assess mental well-being, mood, pain, anxiety, etc.

The disclosed system may therefore provide a single composite measurement, such as an overall score or report reflecting a user's overall mental health well-being. In some embodiments, the disclosed system may include information regarding individual risk assessments, such as in the form of a scale from low to high, for specific conditions such as depression, anxiety, their diagnosis in such areas, and the like that make up a user's composite score. The composite score and/or individual risk assessments may be determined based on a user's response to the questions. In some embodiments, the assessment (i.e., report) may include information about a user's prescribed treatment plan, medications, and/or therapy to provide a quick reference for a user and/or health care provider to determine the effectiveness of a current treatment plan.

The resulting assessment may be transmitted back to an originating service provider computer/server/communication device and stored in a data storage device, such as a database. The data may be accessed in a secure fashion via, for example, the Internet to aid both the patient and their health care provider in tracking the state and progress of the mental well-being of the user.

In some embodiments, the data storage device may be queried to display trends over varying time intervals (e.g., days, weeks, months, or even years) at any time in the past. For example, the system can include a graphical output that displays the daily total score and derivative indexes for a metric, such as anxiety, anger, sadness, and/or lack of pleasure. In some embodiments, the reports can be shared with a health care provider. In addition, the disclosed system and method may provide a mechanism to automatically notify a designated person (i.e. health care provider, family member, emergency contact, and the like) if the user does not respond or the response triggers a threshold value. For example, if the user has acute and severe symptoms for a predefined duration and severity, the user's health care provider may automatically be notified. Advantageously, the disclosed method allows a user (and/or health care provider) to detect developing or worsening of a mental health condition, such as anxiety or depression. To this end, a user may monitor improvements, focus on problem areas, and/or observe the levels of personal experiences over time. Further, the disclosed system may include a secure web portal for healthcare providers, allowing them to monitor and track a user's well-being outside the office. It should be appreciated that the disclosed system meets HIPAA standards and meshes with the Affordable Care Act.

In some embodiments, the disclosed system may provide activity and life event logging, such that a user can input information as needed. For example, if a user loses their job, they can input that information into the system dashboard to provide additional information about mental well-being. In some embodiments, the system may interface and obtain information from a user's work calendar and/or personal calendar for activity and life event logging. Further, in some embodiments, the disclosed system may provide healthcare provider-to-user in-app communications to allow the health care provider to communicate directly with the user, and vice versa. In some embodiments, the disclosed system may include user and health care provider groups and forums.

Accordingly, the presently disclosed subject matter allows for measurement of subjective stressful experiences in the mental health space using current mobile technology. Ease of use and dashboard reporting allow a user's vital sign of the mind to be tracked. The tracking may be the basis for measurement-based care and/or shared decision making in the treatment of a mental health issue (i.e., anxiety and/or depression in some embodiments). The disclosed system and method may be used as part of a platform solution in telemedicine and Employee Assistance Program (EAP) where intelligence is gathered about the user through self-measurement as a precursor to (or in addition to) consultation by the health care provider or triage through telemedicine. A secure web portal may provide an interface to a telemedicine provider and/or an EAP administrator.

In some embodiments, the disclosed system may identify (e.g., automatically identify) a treatment plan. For example, the disclosed system may identify one or more medications that alleviate a particular condition, such as anxiety. In some embodiments, the system may identify whether to consult a healthcare professional and/or take, adjust, change, and/or discontinue a medication associated with a user depending in whole or in part upon the user's mental well-being. In some embodiments, the user may be advised to contact a pharmacist, a nurse and/or doctor, and/or be given an appointment to be examined. In some embodiments the system may be used in conjunction with clinical trials for certain pharmaceuticals or researchers to monitor the mental well-being of a patient within the trial to monitor the vital signs of the mind and possible impact of drug therapy on mental and medical conditions over time.

Thus, the presently disclosed subject matter provides an easy to use system and method that enables the measurement of a user's vital sign of the mind to ascertain mental well-being. In addition, the disclosed system provides advantages for mental health professionals as well as users, including time and cost savings, flexible and discreet nature of delivery, and potential scalability.

Although the presently disclosed subject matter discusses primarily mental health well-being, it should be appreciated that the disclosed system and method may be used to monitor any of a wide variety of disease management, such as (but not limited to) heart disease, diabetes, cancer and the like.

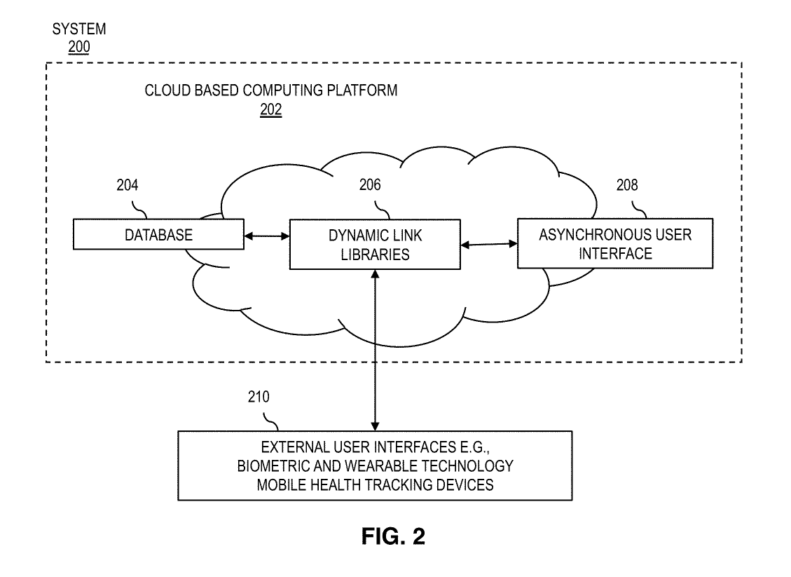

FIG. 2 illustrates a block diagram of a system 200 for providing measurement and monitoring of mental health well-being of a patient for a healthcare provider in accordance with embodiments of the present disclosure. A least a portion of the system may be hosted on a cloud based computing platform 202.

The cloud based computing platform 202 may be one or more servers and may include a virtual server running over a hypervisor. In some embodiments, the virtual server may be an Ubuntu® server or the like. The virtual server may be implemented within the Microsoft Azure® cloud computing data center environment or the like. In other embodiments the server may be hosted within a premise of a healthcare provider or other type of data center.

The system 200 may include database 204, dynamic link libraries 206, and an asynchronous user interface 208. The system may also include external user interfaces 210. The external user interfaces 210 may be configured to provide one or more secure web portals.

Individual patient accounts may be created and stored exclusively in the database 204. Patient survey scores may be initially calculated using proprietary algorithms. These calculations may be compiled into the dynamic link libraries 206 in order to ensure data encapsulation. Once calculated these scores may be stored in the database 204 in normalized database tables indexed by patient, survey type, and date/time for aggregation and analysis. All raw patient scores may be stored for ongoing aggregation and analysis. Data may be encrypted using Microsoft® structured query language (SQL) transparent data encryption (TDE) to meet various compliance and security requirements such as HIPPA compliance.

Data received and/or modified by the system 200 may be first processed using proprietary business rules residing in the dynamic link libraries 206 before being stored in the database 204 and/or being displayed to the patient and/or the healthcare provider. Data definition language (DDL) may be created and compiled using the Microsoft® .NET framework and the C# programing language.

The asynchronous user interface 208 may provide coupling between various patient and health provider GUIs and the dynamic link libraries 206. The asynchronous user interface 208 may also function asynchronously using a combination of custom JavaScript®, JQuery®, and JSON® libraries in order to facilitate best performance and flow for the patient and/or the healthcare provider. Form related interactions may be submitted using bisynchronous client/server submission as dictated by processing requirements.

In some embodiments, the system 200 may also receive at least one of an electronic medical record (EMR) from a health provider's system and an electronic health record (EHR) from an EHR system for the user. The EMR may be a digital version of a paper chart that contains all of the user's medical history from one health provider practice. The user's EMR may be used by the health provider for diagnosis and treatment of the user. The user's EHR may contain and share information from a plurality of health providers involved with the user's care. In general, a user's EHR data may be created, managed, and consulted by authorized health providers and their staff from across more than one health care organization. The EHR system and/or the health provider's system may be integrated with the system 200 over the one or more networks disclosed earlier in this specification. The system 200 and the EHR system may also be integrated to be compliant with the Consolidated Clinical Document Architecture (CDA) markup standard developed by Health Level 7 International (HL7) or the like.

The system 200 may be configured such that all communications containing a patient's protected health information are exchanged in a secure manner that complies with all relevant U.S. Federal regulations, including the regulations mandated by the US Health Insurance Portability and Accountability Act (HIPAA).

Additional data monitoring devices such as a wearable user device may be provided to monitor user elements, such as physical activity, movement, places visited, heart rate, temperature, sleep patterns, and the like. In certain embodiments a fitness tracker (e.g. Fitbit Surge®, Apple Watch® Nike+, Garmin Forerunner® 735XT, or the like) may be used as the wearable device. In some embodiments, the wearable device may communicate directly with the remote computing device over a personal area network (PAN). For example, a fitness tracker may communicate with a smartphone over a Bluetooth® connection. The server may communicate directly with the wearable user device or communicate via an app on the remote computing device. The server may receive the various sources (e.g., the remote computing device, EHR systems, EMR systems, and wearables) and make determinations about patient mental health as further disclosed herein.

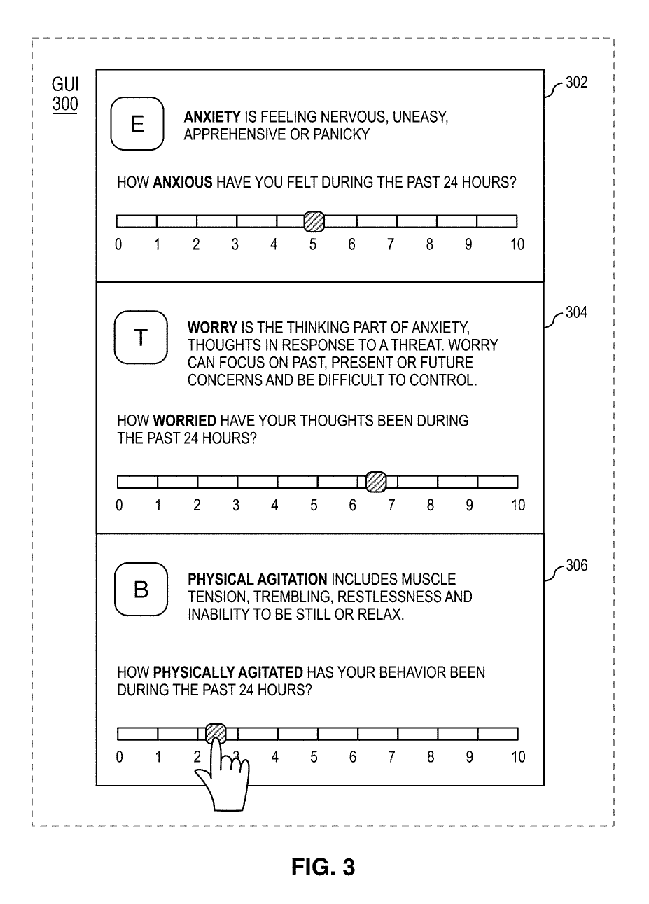

FIG. 3 illustrates another GUI 300 displaying a plurality of questions in accordance with embodiments of the present disclosure. An emotion category question 302, a thought category question 304, and a behavior category question 306 are displayed in the GUI 300.

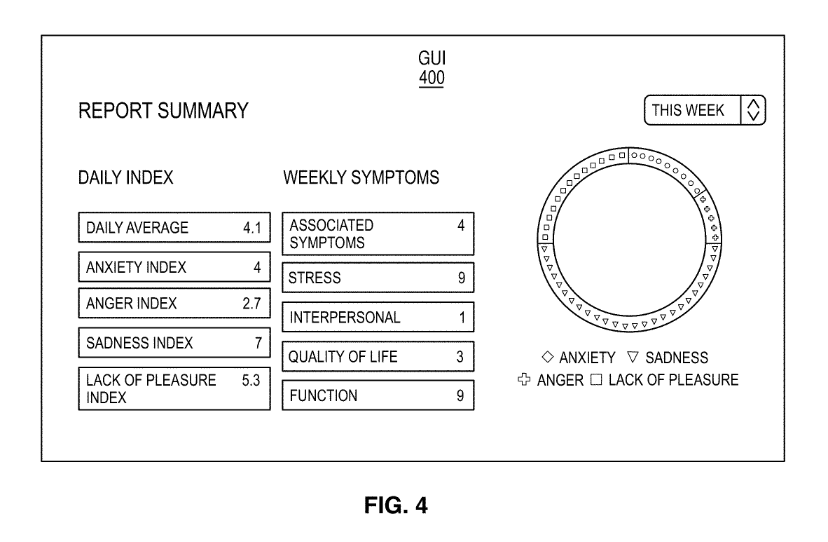

In response to the questions, areas of concern and areas where the user is performing well may be displayed for the user. FIG. 4 illustrates a GUI 400 displaying an example daily and weekly report summary of a patient's symptoms in accordance with embodiments of the present disclosure.

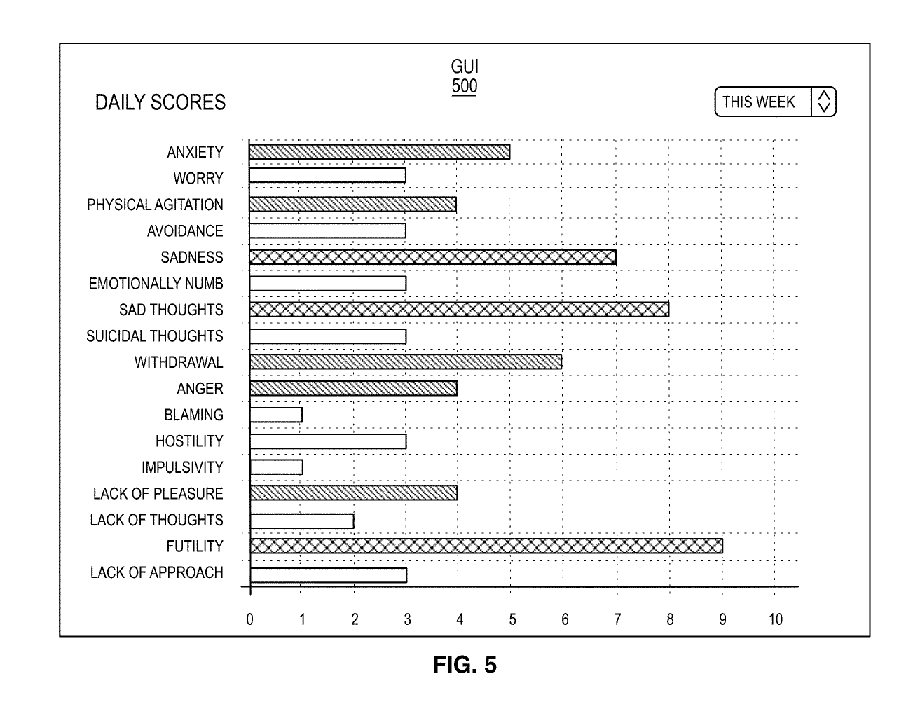

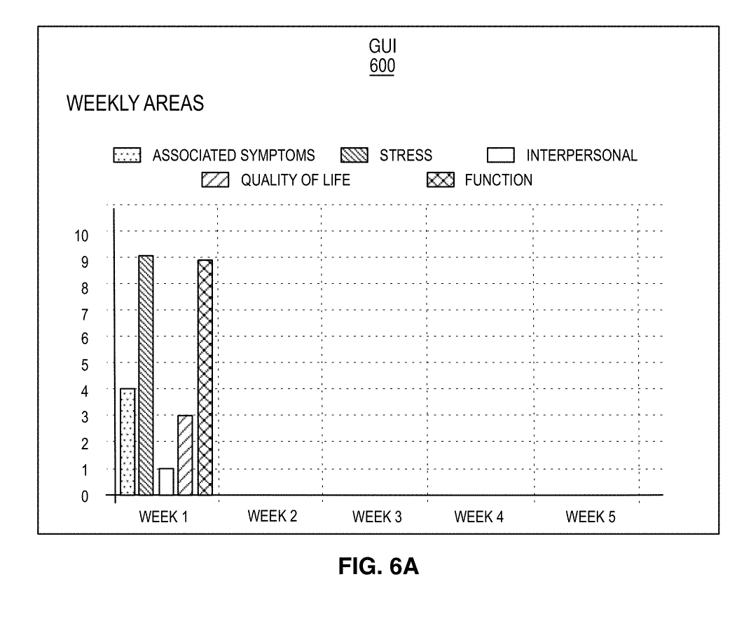

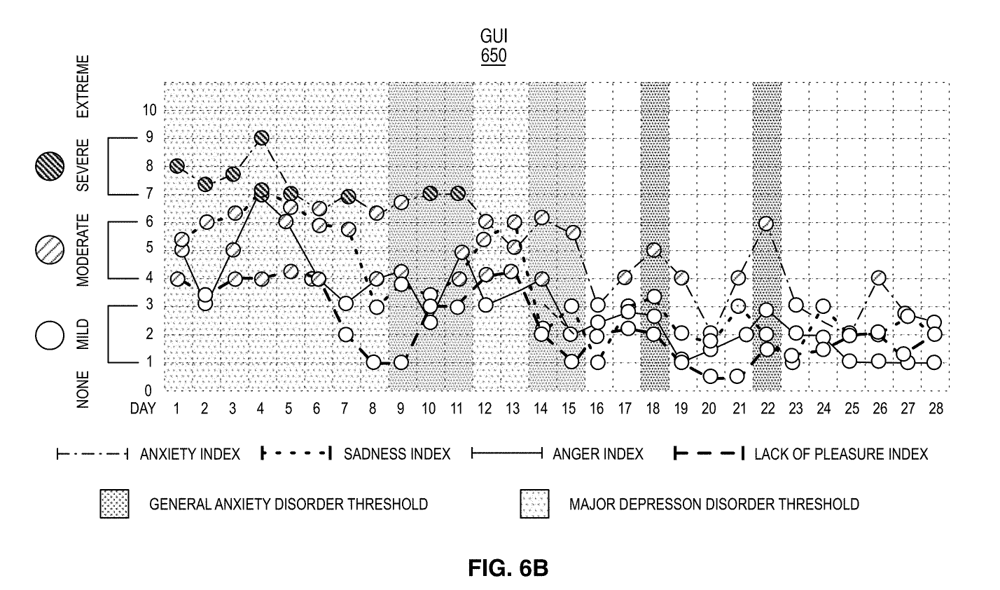

FIG. 5 illustrates a GUI 500 displaying a patient's symptoms as a bar chart for daily scores in accordance with embodiments of the present disclosure. FIG. 6A illustrates a GUI 600 displaying a patient's symptoms as a histogram with weekly intervals in accordance with embodiments of the present disclosure. FIG. 6B illustrates a remote computer device GUI 650 displaying a patient's symptoms as a monthly x-y plot over time in accordance with embodiments of the present disclosure.

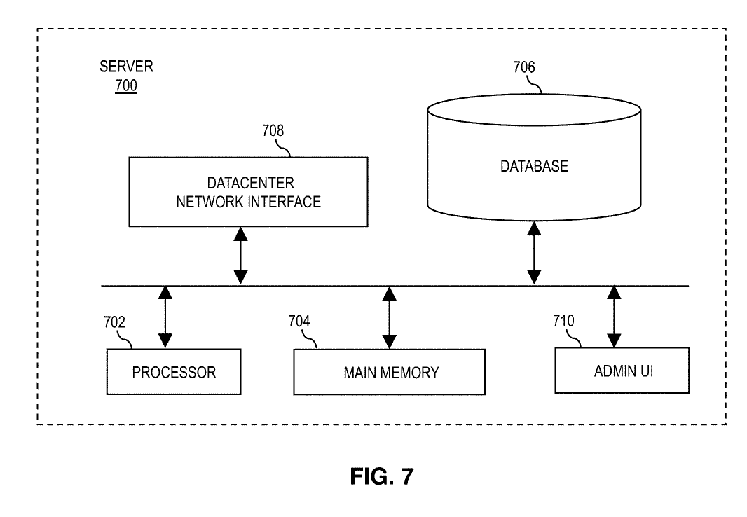

FIGS. 7-9 provide examples of hardware components that may be used to implement one or more portions of the system 200.

FIG. 7 illustrates a block diagram of a server 700 for hosting at least a portion of the system 200. The remote server 700 may include at least one of a processor 702, a main memory 704, a storage memory (e.g. database) 706, a datacenter network interface 708, and an administration user interface (UI) 710. The remote server 700 may be configured to host the Ubuntu® server discussed earlier. In some embodiments Ubuntu® server may be distributed over a plurality of hardware servers using hypervisor technology.

The processor 702 may be a multi-core server class processor suitable for hardware virtualization. The processor may support at least a 64-bit architecture and a single instruction multiple data (SIMD) instruction set. The main memory 704 may include a combination of volatile memory (e.g. random access memory) and non-volatile memory (e.g. flash memory). The database 706 may include one or more hard drives.

The datacenter network interface 708 may provide one or more high-speed communication ports to the data center switches, routers, and/or network storage appliances. The datacenter network interface 708 may include high-speed optical Ethernet, InfiniBand (IB), Internet Small Computer System Interface (iSCSI), and/or Fibre Channel interfaces. The administration UI may support local and/or remote configuration of the remote server 700 by a data center administrator.

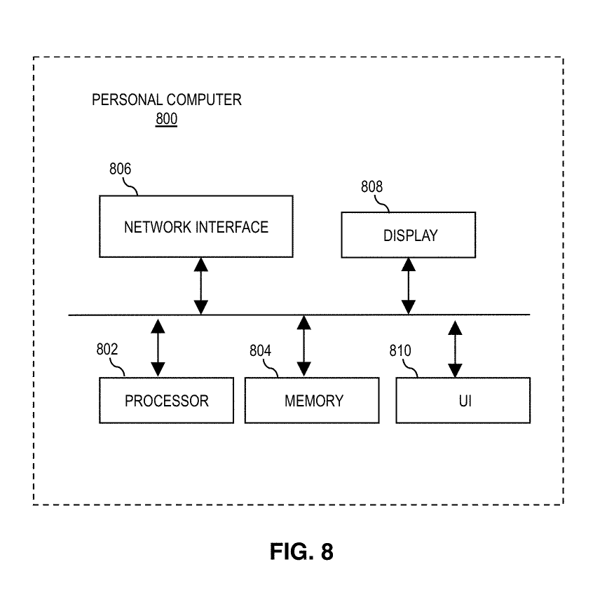

FIG. 8 depicts a block diagram illustrating an example of a personal computer 800. In some embodiments, the personal computer 800 may host the web application. The personal computer 800 may include at least a processor 802, a memory 804, a network interface 806, a display 808, and a user interface (UI) 810. The personal computer 800 may include an operating system (OS) to run a web browser or a computer application specific to the disclosure. The operating system (OS) may be a Windows® OS, a Macintosh® OS, or a Linux® OS. The web browser may be a Microsoft Internet Explorer® browser, a Microsoft Edge® browser, an Apple Safari® browser, a Google Chrome® browser, a Mozilla Firefox® browser, an Opera® browser, or the like. The memory may include a combination of volatile memory (e.g. random access memory) and non-volatile memory (e.g., solid state drive and/or hard drives).

The network interface 806 may be a wired Ethernet interface or a Wi-Fi interface. The personal computer 800 may be configured to access remote memory (e.g. network storage and/or cloud storage) via the network interface 806. The display 808 may be an external display (e.g. computer monitor) or internal display (e.g. laptop). The UI 810 may include a keyboard, and a pointing device (e.g. mouse).

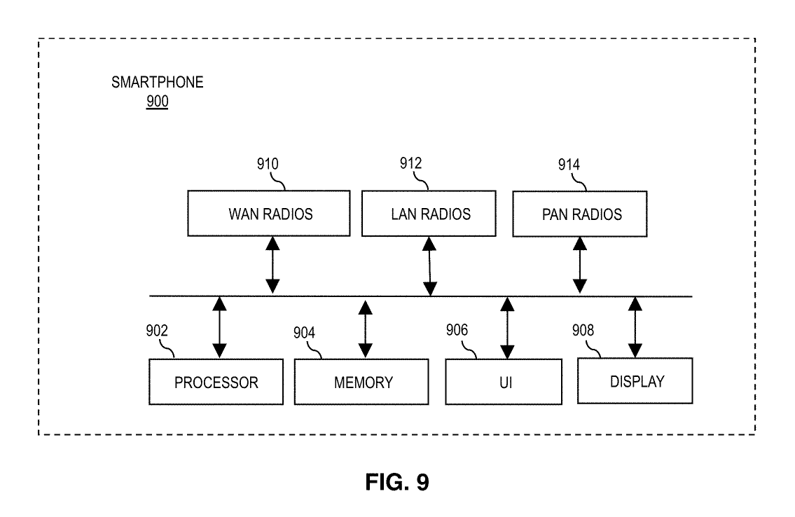

FIG. 9 illustrates a block diagram of a smartphone 900 in accordance with embodiments of the present disclosure. In some embodiments, the smartphone 900 may host the web application. In some embodiments, a web browser or a mobile app specific to the disclosure may provide the user interface to the system 200. The smartphone 900 may include at least a processor 902, a memory 904, a UI 906, a display 908, WAN radios 910, LAN radios 912, and personal area network (PAN) radios 914. In some embodiments the smartphone 900 may be an iPhone® or an iPad®, using iOS® as an OS. In other embodiments the smartphone 900 may be a mobile terminal including Android® OS, BlackBerry® OS, or Windows Phone® OS.

In some embodiments, the processor 902 may be a mobile processor such as the Qualcomm® Snapdragon™ mobile processor. The memory 904 may include a combination of volatile memory (e.g. random access memory) and non-volatile memory (e.g. flash memory). The memory 904 may be partially integrated with the processor 902. The UI 906 and display 908 may be integrated such as a touchpad display. The WAN radios 910 may include 2G, 3G, 4G, and/or 5G technologies. The LAN radios 912 may include Wi-Fi technologies such as 802.11a, 802.11b/g/n, and/or 802.11ac circuitry. The PAN radios 912 may include Bluetooth® technologies.

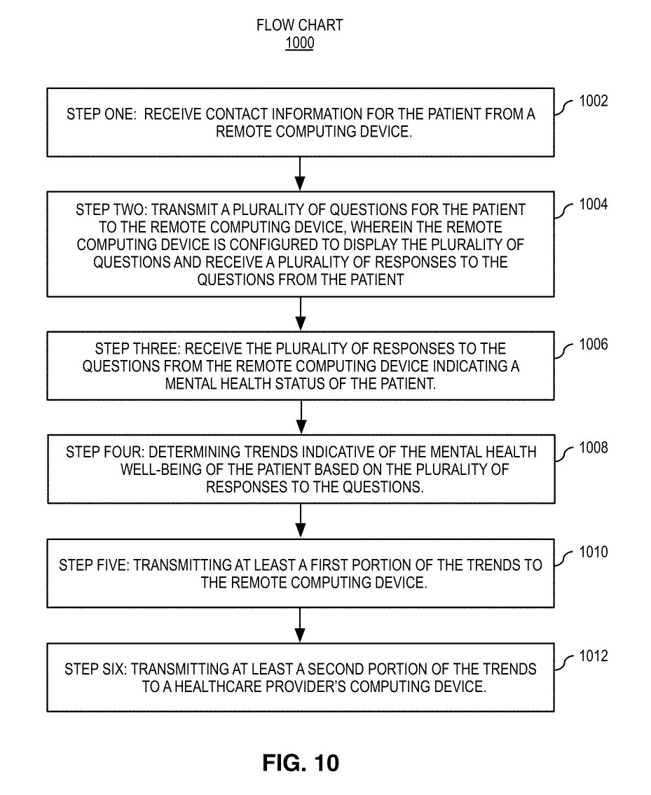

FIG. 10 illustrates a flow chart 1000 of a method implemented on the server for providing measurement and monitoring of mental health well-being of a patient for a healthcare provider.

In step one 1002, the server receives contact information for the patient from a remote computing device. Contact information may include a full name of the user, a birth date, a social security number, a medical insurance number, and/or a user identification (ID) associated with a health care provider.

In step two 1004, the server transmits a plurality of questions for the patient to the remote computing device and the remote computing device is configured to display the plurality of questions and receive a plurality of responses to the questions from the patient. The each question of the plurality of questions may be categorized as one of an emotion, a thought, and a behavior.

In step three 1006, the server receives the plurality of responses to the questions from the remote computing device indicating a mental health status of the patient. The responses may be received from the patient via a GUI as described in FIG. 1 and/or FIG. 3.

In step four 1008, the server determines trends indicative of the mental health well-being of the patient based on the plurality of responses to the questions.

In step five 1010, the server transmits at least a first portion of the trends to the remote computing device of the patient.

In step six 1012, the server transmits at least a second portion of the trends to a healthcare provider's computing device.

As discussed in FIG. 1, the server may be a virtual server hosted in a cloud computing environment, a server located within a healthcare provider premise, or server located in any other type of datacenter.

The conceptual underpinnings of this effort to measure anxiety and depressive symptoms are knowledge not only from psychology, but from all the neurosciences. The premise is that subjective mental experiences are the result of brain activity. The brain gathers information through sensory systems and sequentially and in parallel, processes the information through different levels. Early processing of such input results in the experience of emotions, while later responses result in cognition. Behavioral outputs may be triggered from each of these levels—responses from the sensory level result in reflex behaviors (e.g. knee-jerk); emotional triggers result in pre-programed and conditioned responses; cognitively-derived behaviors can optionally be deliberate, and willfully chosen. The systems are bi-directionally interactive behaviors, emotions bias cognition that can feedback to regulate emotions.

Activation at limbic centers that is critical for emotions are negatively or positively balanced to address threat or reward. These have survival value for the individual and species. The fear response system has its hub in the amygdala. The amygdala is hard wired to respond to threat. Activation of the threat response is intrinsically programmed and does not have to be learned, and is manifested as the ‘flight or fight’ response. The pattern of behaviors in these responses is consistent across humans. What are learned in life are the associations to when the response has been triggered by pattern recognition from sensory or other input. Such associative learning occurs within the amygdala, enhanced by contextual conditioning mediated through circuits including the hippocampus. The hippocampus provides orientation for the contexts and due to its role in memory is an important hub for contextual conditioning. Repeated exposure to threat can sensitize the threat response, while continuous exposure can result in habituation. New learnings result in extinction, though renewal (re-awakening) can also occur.

The threat response can be divided into an initial phase that can result in anxiety if internalized or anger if externalized. Repeated exposure can result in a later phase of response akin to ‘learned helplessness’ associated with sadness.

The other system is a reward system with its anatomical hub in the nucleus accumbens where the response is the subjective experience of pleasure. The triggers for this response are also hard-wired, with associative conditioning resulting in learned triggers. However, an important distinction from the threat response system is the habituation of responses to repeated triggers. Thus, novelty is an important mediator of activation, hence the approach towards novelty-seeking behaviors that are associated with the activation of the reward system.

Such a comprehensive theoretical model underlies the basis of the experience of anxiety and depression and the disorders that emanate from these symptoms are the theoretical basis for the development of the new scale.

### Scale Development

Emotions, Thoughts and Behaviors (ETB) are a self-report measure of anxiety and depression, associated symptoms and disability. ETB can be administered on a mobile device or personal computer in a platform independent manner. ETB translates the research domain criteria (RDoC) approach to clinical trials and practice, redefining the clinical symptoms of various anxiety and depressive disorders in terms of the hierarchical and recursive brain systems mediating emotions and thinking, and their product—behavioral actions. To provide clarity and enhance precision, terms used in the scale are succinctly described before the corresponding question, which is a unique approach in self-report measures. The time and burden of assessment is taken into consideration in making choices of which symptoms need daily assessment (i.e., they commonly fluctuate) versus those that can be reliably condensed for weekly assessment. Thus, there are two parts to ETB—a daily part comprising 17 questions to be answered daily, and a weekly part also with 17 questions. Scores from the two can be incorporated to provide varying granularity for analysis.

### Validation Study

The study protocol and informed consent form were approved by the East Carolina University Institutional Review Board. A sample of 198 adults, literate in English, provided informed consent. The participants reflected the general population in the region. An individual could participate only once.

On a computer, the subject provided demographic information (age, sex, race/ethnicity, socio-economic information and educational level), and whether they were receiving professional treatment (psychotherapy or medication) for anxiety and/or depression. Subjects viewed a 5 minute introductory video on the scale, and completed daily and weekly sections of the scale on a laptop computer. The subjects subsequently answered a series of questions to provide feedback on the scale, also on the computer. Subjects filled out a reference scale, the Hospital Anxiety and Depression Scale (HADS).

The version of the scale used in the study had 20 daily questions and 14 weekly questions. The daily questions included six related to emotions (anxiety, anger, sadness, emotional numbness, lack of pleasure and lack of compassion), seven related to cognitions (worry, blaming, sad thoughts, suicidal thoughts, lack of thoughts, futility and distrustful) and seven related to behaviors (physical agitation, avoidance, hostility, impulsivity, withdrawal, lack of approach and asocial). Each item was described (e.g., “Anxiety is feeling nervous, uneasy, apprehensive or panicky”) before the question was asked (e.g., “During the past 24 hours, how anxious have you felt?”). Scoring was 0-10 with descriptive guidance provided (i.e., 0 was labeled as none and 10 as extreme, 1-3 as mild, 4-6 as moderate and 7-9 as severe).

The weekly questions were divided into eight questions related to associated symptoms such as sleep, appetite, fatigue, a single question on quality of life, and five questions on functioning in the domains of social, work, school, home and hygiene/grooming.

Scoring was as follows: the scores for the daily questions were totaled and divided by the number of questions to provide a total average item score. Index scores for each of the five indexes (anxiety, anger, sadness, anhedonia and social) were calculated as the average of three items including one each from emotion, thought and behavior. When there were two items for a particular category (i.e., physical agitation and avoidance as behaviors in the anxiety index), the higher score was used in calculating the index. The approach provided equal weighting for the three categories of emotion, thought, and behavior for each index. The score for functional restriction was the highest score among the five questions related to functioning.

### Statistics

Data was screened to detect outliers and distributional abnormalities. The demographic data was used to describe the sample. The internal consistency (reliability) was assessed for the total scores of the ETB and the Hospital Anxiety and Depression Scale (HADS). A Cronbach's coefficient alpha above 0.7 was considered the threshold for acceptability.

The ETB item scores were subjected to analysis to determine the number and nature of the subscales that were expected to exist. Parallel analysis and Velicer's minimum average partial (MAP) Test was employed to determine the number of factors to extract with an exploratory principal axis factor analysis with varimax rotation. It was expected that there would be five distinct factors: anxiety, sadness, anger, lack of pleasure, and asociality. A confirmatory factor analysis was conducted to estimate the fit between the data and the expected structure and to determine what modifications were needed in the structural model.

Once decisions were made regarding the number and nature of the subscales, the internal consistency (reliability) of each of the subscales was estimated with Cronbach's coefficients alpha. The convergent validity of the ETB subscales was assessed by examining the relationship between ETB subscale scores and the two subscale scores from the HADS. A Pearson's correlation coefficient above 0.5 was considered a large strength of association.

### Results

A total of 198 subjects provided informed consent and provided data. Data was downloaded from the server as a spreadsheet, reviewed, and cleaned. One subject with Down's Syndrome was recruited in error and was unable to complete the task. Her data was excluded. Two subjects filled out the scale with a degree of inconsistency that illiteracy was suspected and their data were excluded.

Demographics information of the study is provided in TABLE 1.

TABLE 1

| | |
|---|---|
| Age (mean + S.D.) | 39.8 + 18.66 |
| | (range 18-83) |
| Female | 58% |
| Race | |
| Caucasian | 71% |
| African American | 21% |
| Asian | 5% |
| Other | 3% |
| Ethnicity | |
| Hispanic | 4% |
| Marital status | |
| Single | 41% |
| Married/Committed | 59% |
| Education | |
| Attended high school | 4% |
| High School graduate | 39% |
| College graduate | 56% |
| Economic status | |
| Lower | 10% |
| Middle | 76% |
| Upper | 14% |
| Receiving professional care | 24% |
| for anxiety/depression: | |
| Psychotherapy: | 10% |
| Medication: | 18% |
| Self-estimated time to answer | 7.3 + 4.8 minutes |
| ETB Daily: | |
| Self-estimated time to answer | 6.0 + 3.8 minutes |
| ETB Weekly: | |

Cronbach's alpha coefficients for the 17-item Daily ETB are provided in TABLE 2.

TABLE 2

| | Mean | +S.D. | Range | Cronbach's Alpha |
|---|---|---|---|---|
| ETB Daily Total | 30.5 | 22.84 | 0-106 | 0.94 |
| Anxiety index | 8.6 | 5.66 | 0-23 | 0.85 |
| Sadness index | 5.9 | 5.91 | 0-25 | 0.86 |
| Anger index | 5.9 | 5.91 | 0-27 | 0.81 |
| Anhedonia index | 5.0 | 5.13 | 0-25 | 0.84 |
| Asocial index | 5.0 | 4.69 | 0-23 | 0.63 |
| HADS Total | 11.5 | 6.20 | 0-31 | 0.86 |
| HADS Anxiety | 7.79 | 3.79 | 0-19 | 0.81 |
| HADS Depression | 3.7 | 3.25 | 0-16 | 0.81 |

Pearson's correlation coefficients for ETB and HADS are provided in TABLE 3.

TABLE 3

| | HADS Anxiety | HADS Depression |
|---|---|---|
| ETB Anxiety Index | 0.66 (p < 0.001) | 0.49 (p < 0.001) |
| ETB Sadness & | 0.58 (p < 0.001) | 0.62 (p < 0.001) |
| Anhedonia Indexes | | |

### Discussion

The initial validation study of ETB demonstrated excellent internal consistency as a proxy for reliability. Sex, race and ethnicity did not impact the total ETB scores. Higher ETB scores were associated with lower economic status and education, being single, receiving professional care, and being a college student.

Factor analysis supported the index structure of the Daily ETB for anxiety, anger, sadness, and anhedonia. The asocial index was removed, as its Cronbach's alpha coefficient was 0.63, below the acceptable threshold. The item measuring impulsivity fell into both the anger as well as the anhedonia indexes, and should be explored in subsequent studies. The withdrawal item overlapped with the asocial item and therefore the description was rewritten to clarify the motivation tied to the behavior—“behaviorally retreat to seek solace, comfort in distress”.

ETB indexes had a large convergent validity against the HADS subscales, an accepted standard. An algorithm derived from the Diagnostic and Statistical Manual of Mental Disorders (DSM-5) criteria for major depressive disorder (MDD) and generalized anxiety disorder (GAD) suggested that 11.8% meet criteria for GAD and 14.9% for MDD. The validity of these algorithms should be tested prospectively in studies that employ clinician-based diagnoses.

Learnings from the studies have modified the ETB to create a daily and a weekly version, each with 17 items. The items measuring social measures have been modified to reflect interpersonal functions tied to social neuroscience.

Thus, going forward, the ETB will have 17 items in the daily version reflecting 4 indexes—Anxiety (D1-4), Anger (D10-13), Sadness (D5-9), and Anhedonia (D14-17). The ETB Weekly version will also have 17 items—Associated Symptoms (W1-7), Stress (W8), Interpersonal (W9-11), Quality of Life (W12) and Dysfunction (W13-17)

The guidance by the United States Food and Drug Administration (FDA) for the development of a patient reported outcome (PRO) measure required interviewing patients as the initial step. Such a requirement was appropriate when subjective reporting was the sole basis of the report. However, when an RDoC framework is included, the initial version of the scale should be developed with expert knowledge and subsequently tested among subjects with a spectrum of symptoms within the appropriate domains.

Thus, the emotion of jealousy is a social one by its interpersonal nature, and may be driven by threat of loss, anxiety/anger, and issues of self (such as confidence, stability, and insecurity).

Words particularly charged ones describing emotions, often have varying connotations to different individuals. The ETB provides descriptors for items in an attempt to forge a common language for the understanding of a term. The goal is to reduce variance due to shifting perceptions of what an item means.

The period of time under assessment was artificially divided into daily or weekly based on the potential fluctuation of experiences, and an individual's capacity to synthesize valid experiences over a longer period of time (daily and weekly). The distinction was also driven by the practical need to minimize the burden of items that need to be filled out daily.

The actual rating was based on a 10-point scale (standard in medicine). Various attempts to provide guidance were incorporated.

The scale is under development, and validation studies are needed prior to a final version. The ETB was a preliminary approach to balance the knowledge reflected in the current RDoC version with the DSM-5 approach in the clinical space of anxiety and depression. The ETB has made what may be considered arbitrary choices in the symptoms being assessed. The choices are driven by utility, and practicality. One area poorly assessed was the somatic component of anxiety and depression. The somatic marker hypothesis of emotions posited that somatic (visceral) sensory input provided the framing for emotions activated by ‘limbic’ hubs (amygdala for negative affect and acumens for positive affect). Thus, an emotional experience can be derived from somatic messages or the activation of the hubs. The ETB had only one item that measured somatic symptoms reflecting such a position—‘lack of well-being’ defined as generally feeling ill or unwell.

The ETB also required a level of sophisticated awareness of subjective processes, breaking down a complex experience into component parts. The psychometrics of the scale will be enhanced with practice and experience. A period of training, whereby the terms and their definitions are matched with an individual's experience. This may be easy for some and difficult for others. Data from further validation studies may be used to explore whether the ETB has better signal detection properties than current rating scales.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, or the like. The program code may execute entirely on the user's computer, partly on the user's computer, as a stand-alone software package, partly on the user's computer, and partly on a remote computer or entirely on the remote computer or server.

Aspects of the present invention are described in the instant specification with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a user” can include a plurality of such users, and so forth. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

what is claimed is:

1. A method implemented on a server for providing measurement and monitoring of mental health well-being of a patient for a healthcare provider, the method comprising:
receiving contact information for the patient from a remote computing device;
transmitting a plurality of questions for the patient to the remote computing device, wherein the remote computing device is configured to display the plurality of questions and receive a plurality of responses to the questions from the patient;
receiving the plurality of responses to the questions from the remote computing device indicating a mental health status of the patient;
determining trends indicative of the mental health well-being of the patient based on the plurality of responses to the questions;
transmitting at least a first portion of the trends to the remote computing device; and
transmitting at least a second portion of the trends to a healthcare provider's computing device.

2. The method of claim 1, wherein the method further comprises providing Health Insurance Portability and Accountability Act (HIPAA) compliant access for the remote computing device and provides HIPAA compliant communication to the healthcare provider's computing device.

3. The method of claim 1, wherein the second portion of the trends are formatted to be used to determine a course of treatment for the patient by the healthcare provider.

4. The method of claim 1, wherein transmitting the second portion of the trends is based on the plurality of responses to the questions exceeding at least one of a specified criterion for a predefined action and a predefined severity level to a single response.

5. The method of claim 1, wherein the plurality of questions are transmitted to the remote computing device on a periodic interval.

6. The method of claim 1, wherein the plurality of questions comprise patient information requests, the patient information requests including at least one of emotions, thoughts, and behaviors.

7. The method of claim 1, wherein the remote computing device is at least one of a smartphone, a tablet, a laptop, and a personal computer.

8. The method of claim 7, wherein the plurality of questions is displayed to the patient and the plurality of responses is received from the patient via a graphical user interface (GUI).

9. The method of claim 8, wherein the GUI is provided by an application specific program.

10. The method of claim 8, wherein the GUI is provided by a web browser.

11. A server for providing measurement and monitoring of mental health well-being of a patient for a healthcare provider, the server comprising
a memory;
a database; and
a processor configured for:
receiving contact information for the patient from a remote computing device;
transmitting a plurality of questions for the patient to the remote computing device, wherein the remote computing device is configured to display the plurality of questions and receive a plurality of responses to the questions from the patient;
receiving the plurality of responses to the questions from the remote computing device indicating a mental health status of the patient;
determining trends indicative of the mental health well-being of the patient based on the plurality of responses to the questions;
transmitting at least a first portion of the trends to the remote computing device; and
transmitting at least a second portion of the trends to a healthcare provider's computing device.

12. The server of claim 11, wherein the processor is further configured for providing Health Insurance Portability and Accountability Act (HIPAA) compliant access for the remote computing device and provides HIPAA compliant communication to the healthcare provider's computing device

13. The server of claim 11, wherein the second portion of the trends are formatted to be used to determine a course of treatment for the patient by the healthcare provider.

14. The server of claim 11, wherein transmitting the second portion of the trends is based on the plurality of responses to the questions exceeding at least one of a specified criterion for a predefined action and a predefined severity level to a single response.

15. The server of claim 11, wherein the plurality of questions are transmitted to the remote computing device on a periodic interval.

16. The server of claim 11, wherein the plurality of questions comprise patient information requests, the patient information requests including at least one of emotions, thoughts, and behaviors.

17. The server of claim 11, wherein the remote computing device is at least one of a smartphone, a tablet, a laptop, and a personal computer.

18. The server of claim 17, wherein the plurality of questions is displayed to the patient and the plurality of responses is received from the patient via a graphical user interface (GUI).

19. The server of claim 18, wherein the GUI is provided by an application specific program.

20. A non-transitory computer readable medium comprising a plurality of machine-readable instructions which when executed by one or more processors of a server are adapted to cause the server to perform a method for providing measurement and monitoring of mental health well-being of a patient for a healthcare provider, the method comprising:
providing Health Insurance Portability and Accountability Act (HIPAA) compliant access for a remote computing device using a first secure web portal;
receiving contact information for the patient from the remote computing device;
transmitting a plurality of questions for the patient to the remote computing device requesting information from the patient based on at least one of emotions, thoughts, and behaviors, wherein the remote computing device is configured to display the plurality of questions and receive a plurality of responses from the patient;
receiving the plurality of responses to the questions from the remote computing device indicating a mental health status of the patient;
determining trends indicative of the mental health well-being of the patient based on the plurality of responses to the questions;
transmitting at least a first portion of the trends to the remote computing device;
providing HIPAA compliant communication to a healthcare provider's computing device using a second secure web portal; and
transmitting at least a second portion of the trends to the healthcare provider's computing device based on the plurality of responses to the questions exceeding at least one of a specified criterion for a predefined action and a predefined severity level to a single response.
